(19) United States
(12) Patent Application Publication
(10) Pub. No.: US 2014/0180445 A1
(43) Pub. Date: Jun. 26, 2014

(54) USE OF NATURAL LANGUAGE IN CONTROLLING DEVICES

(71) Applicant: Michael Gardiner, West Vancouver (CA)

(72) Inventor: Michael Gardiner, West Vancouver (CA)

(21) Appl. No.: 14/162,453

(22) Filed: Jan. 23, 2014

Related U.S. Application Data
(62) Division of application No. 10/908,369, filed on May 9, 2005.

(51) Int. Cl. G05B 15/02; G06F 17/28

(52) U.S. Cl. CPC G05B 15/02; G06F 17/28
USPC 700/83

(57) ABSTRACT

The invention discloses methods and apparatus based on tabular concepts which greatly simplify the configuration, maintenance and run-time operations of a broad range of electronic equipment control systems, including, but not limited to: (a) industrial controls, (b) supervisory control and data acquisition, such as heating, ventilation and air conditioning, and (c) home automation, including systems or stand-alone equipment, such as video recording devices. The tabular concepts of the invention are applied in three primary stages, namely (i) data input or configuration, including automated data population, (ii) generic operating rule application to tables of rules data variables, and (iii) English (or other) language translations of the current rule sets, for ease of verification. By each of these methods alone and through combination of all of these methods, the current invention makes the configuration and operation of automated equipment easily accessible to persons who do not have technical skills in either process control, automation, or software programming. Development of software for automatic control of equipment is also greatly simplified by these inventions.

### RELATED APPLICATION

This application is a divisional of U.S. patent application Ser. No. 10/908,369, filed on May 9, 2005, which is hereby incorporated by reference in its entirety.

### FIELD

This invention relates to the field of equipment automation or control, including but not limited to industrial equipment, other commercial equipment systems and home automation systems. The field of the invention is very broad. It applies to virtually any automation system, since it is capable of an extensive range of control features and functionality. By using a table driven method, that is simple to configure and operate, the invention enables control system implementation and operation by persons without technical expertise in the field of automation. The invention also pertains to the ease of use of any programmable device, like a thermostat or video recorder. English language translations are provided for current device settings, simplifying device usage by persons without technical expertise.

### BACKGROUND

The current invention represents an entirely new approach to configuration and control within the field of equipment automation. Patents reviewed, which represent prior art in this field, were found to be generally narrow in scope or application specific. No single patent or collection of patents was located which resembles the concepts or scope of the current invention. Instead, general areas of automation are reviewed here. Automation system approaches that are currently best in class in their industry sector are described. The field of equipment automation has been divided into three broad sectors, each of which is addressed separately.

(a) Traditional industrial control using Programmable Logic Controllers (PLCs),

(b) Alternate industrial control, using personal computer based supervision in combination with proprietary intelligent controller products, often for specific applications, and

(c) Home automation systems.

(a) Traditional industrial control using Programmable Logic Controllers (PLCs).

Industrial automation systems originated with Programmable Logic Controllers (PLCs) and a wide variety of PLC products are available today which conform to industry standards. PLCs connect to input/output cards housed in cabinets and which are in turn connected to input sensors or output devices. Input device status is interpreted by PLC programs which then determine output device states. The combined system represents an automated industrial control environment.

One of the limitations of a PLC based system is that it requires programming by experts in control applications. PLC programming takes place in ladder logic or in statement language or in function block language. Programming of ladder logic code is inaccessible to persons who are not technically skilled and trained in the field. Concepts such as flags, variables and programming logic are essential to PLC usage.

In early years, light boards would show schematic layouts and equipment operating status, such as valves open or closed, and gauges to show values like tank levels or temperatures. With the introduction of personal computers, more sophisticated Human Machine Interfaces or HMIs were created, with images, alarms, and reporting details. These systems introduce additional layers of complexity in system implementation. In addition to PLC programming, users must understand network technology, as well as HMI development software comprised of numerous components. A typical high end, flexible, scalable and reliable industrial control system includes the following separate components:

Programmable Logic Controllers or PLCs
Remote input/output cabinets and input/output cards
Industry standard input sensors and output device controls
PLC programming software
Standard or proprietary local area network components
Application software for system configuration
Application software for supervisory control tasks
Visualization software for the HMI and operator interaction
Real-time data collection, storage and trend reporting functions
Alarm monitoring, control and reporting functions
Internet portal software, for remote system access

The combination of hardware and software listed here provides a powerful toolset for industrial control applications that are highly flexible, and scalable to large size, while maintaining real-time operation and reliability. Conversely, the limitations of such a system become readily apparent when applied on a smaller scale. For a small facility, only one PLC may be required, but ladder logic programming is still needed. In order to configure a complete system, with a friendly HMI, the facility operator is then confronted with the addition of virtually all of the software modules listed above. This is a quantum leap in complexity, that may be best illustrated by an example.

Consider a simple system, comprised of a temperature sensor (RTD or resistor/thermistor difference device), and a fan that is switched on automatically at above a set temperature but not turned off until a lower temperature is reached, to avoid frequent cycling of the fan. The example includes a camera to watch the room, and the ability to trend the room temperature over time and to control the fan manually. To enable these simple functions, the traditional industrial control system with PLCs must be implemented via a sequence of non-intuitive activities requiring skills in control system design, networking and PLC programming. Some of the technical elements of the set-up procedures are as follows:
Install PLC hardware and software and connect to separate input/output cabinets with input/output cards and connect the latter to a temperature sensor and fan switch.
Use PLC software to develop tables and addresses for the input/output points, that is, the fan and temperature sensor. Names like “fan” and “temperature” are not valid addresses.
To build an HMI screen, assign icons for the fan and temperature sensor, specifying size, annotation, and animation options, then associate these with the PLC addresses.
To build alarm actions, use an alarm link tool and create a custom application that will work over the internet or a local area network. Program all custom alarm actions.
Implement equipment control logic in PLC ladder logic code, to turn the fan on and off at set temperatures. Temperature is converted to an integer value and scaled. Variables are defined to refer to the input/output point addresses. PLC ladder logic code is complex and cryptic and requires specialized programming skills.
To view data trends, set-up a database or simple query language (SQL) server to collect data from PLC input/output points, including addresses, timing and conditions to be recorded. Install trending and reporting software on a separate computer and connect it to the historical database.
Acquire and install third party software for viewing of camera inputs.
Install and activate internet portal software for remote access.

As seen from the minimum steps listed, the engineering expertise and the total effort required for system configuration and operation, in the traditional industrial control environment using PLCs, is prohibitive for smaller applications. To try to address the problems of complexity and excessive set-up times, alternative approaches have been taken, within the controls industry and in the home automation industry. Both sectors are described next, and the on-going limitations of the current state-of-the-art in each industry sector are highlighted.

(b) Alternate industrial control, using personal computer based supervision in combination with proprietary intelligent controller products, often for specific applications

To overcome the need for labour intensive system set-up by technically skilled persons, applications specific supervisory control systems have arisen in a number of industries. Some examples of this are (i) power transmission monitor and control systems, for which engineers need to know about power systems, but not about computer programming, (ii) HVAC or heating, ventilation and air-conditioning monitor and control systems, (iii) monitoring of vehicle fleets, or (iv) telemetry applications for oil wells. All of these systems have similar characteristics. Control is provided by a combination of personal computers and a variety of intelligent programmable controllers (IPCs). A typical, fully featured HVAC system provides a good example.

A modern HVAC application will include system configuration, viewing and remote internet access. These software packages allow an operator to see details such as room temperatures and fan operation, and to change setpoints for elements of the system. The software will interact with proprietary intelligent programmable controller hardware, using a strongARM or even more powerful microprocessor. Typically, there are a wide variety of input sensors and output switches and actuators that are compatible with the defacto standards of different HVAC suppliers.

Characteristics that are important in terms of defining the state-of-the-art are explored next. The human machine interface (HMI) is application specific. It may use a graphical control language (GCL) that can be understood by trained technicians. Drop down menus assist with configuration and creation of HMI screens using icons and simple program constructs, like the use of variables, logic and conditional states. Over time, these types of systems may acquire an even better “cookbook” approach to simplification of the HMI and programming concepts. Regardless, there are severe limitations in the entire approach, namely:
Expensive, proprietary, intelligent programmable controllers (IPCs) are required.
Extensive conventional applications software must be written to manage the IPCs.
It is not possible to use reliable, low cost standard industrial PLCs in the system, for the majority of proprietary applications specific control systems.
A defacto standard often exists for network and sensor/actuator devices.
The entire system is geared toward a well-defined application, such as HVAC.

There is opportunity for significant improvement in the current state-of-the-art for this category of industrial control, using personal computers, sophisticated applications software, intelligent programmable controllers and pseudo-standard devices. Within these systems, the personal computer and intelligent programmable controllers (IPCs) are usually separated. These two components may be combined without significant reduction in programming complexity. The absence of a discrete IPC is not necessarily an indicator of a simpler system concept. Likewise, the inclusion of a PLC does not obviate the need for extensive applications specific programming by product developers, in order to simplify configuration and operation by end users.

(c) Home Automation Systems

In recent years, a home automation market has evolved, in which the products are theoretically intended to provide automation solutions for most home-owners, who would be only moderately technically skilled at best. Some systems have been created to allow control of home devices using keypads and other wall mounted panels. Other computer based products use a graphical interface to theoretically enable a non-technical user to develop an automation system for home appliances. In practice, this ease-of-use goal has not been achieved.

A major difference between industrial control and home automation is the lack of ability to use industry standard devices or existing applications specific defacto standards. Home systems are restricted to protocols (for example, an X-10 protocol) that are applicable to limited devices. Only one type of analog or digital input and relay output may exist. System components are typically proprietary, so that all system expansion must use the same product line.

Hardware components are acquired and often wired with jumpers. Software is installed for local development, viewing and control. Separate software is used for web viewing only. Automated equipment programming starts with defining all of the components to be used, including names, descriptions, locations, dependencies, and other data, depending on the item. Typically there are protocol specific definitions for each input/output device. To program automatic rules, the user defines timers, timestamps, variables, flags, macros and other components using the configuration software. Program lines are then created using standard if-then-else statements, which can be nested. This requires that the installer has an understanding of programming concepts and is able to think in a linear, structured fashion.

An example is used to illustrate the skills required. The system will turn a fan on if the temperature gets to 77 degrees, and will leave it on until temperature drops to 75 degrees, to avoid rapid cycling of the fan. The rule is to apply every day between 7:00 am and 5:00 pm. The first step is the definition of timers and a schedule. If the fan cannot be directly addressed, a custom relay output is required to interact with the 110 V fan. For the input signal, a standard thermistor is used for temperature measurement. A custom circuit may be needed to convert the thermistor signal into a 0 to 5 V range. An external gain/offset circuit may be recommended. Programming rules are implemented using an “if-then-else” syntax. In this case, a flag called “deadband” is used to represent the 75 to 77 degree temperature band, and ensure that all logical conditions are satisfied. The program rules read as follows:

If Time is After 7:00 am
AND—
Time is Before 5:00 pm
AND—
(Analog In: Room Temperature)>77

Then (F: Deadband Flag) SET

End

If Time is After 5:00 pm

Then (F: Deadband Flag) CLEAR

End

If (Analog In: Room Temperature)<75

Then (F: Deadband Flag) CLEAR

End

If (F: Deadband Flag) SET

Then (Relay Out: Fan) ON

End

Input Device, Output Device—A device is a piece of equipment that performs a function and can be controlled by an automation system, but is not an integral part of the automation system. Example a motor is an output device and a temperature sensor is an input device.

Input Point, Output Point—a point is a location where an input device or output device is connected to the automation system. In the software the point also defines a reference to the location and inherently the input or output device.

HMI—is a Human Machine Interface, to describe a graphical image of the equipment on a computer screen.

Block—a block is a table or array with multiple records, each record having a number of fields in which data elements are stored. Data elements can be values such as numbers, or can be elements such as operators, as noted which the rules variable block, which stores numbers and operators.

Operator—a symbol that denotes or performs a mathematical, logical or comparison operation.

Boolean logic operator—an operation performed by an operator in which each of the operands and the results take one of two values (i.e., true or false).

Comparison operator—compares its operands and returns a logical value based on whether or not the comparison is true.

Special logic operator—an operator that carries out operations which may be mathematical or may be various other operations.

Set-up Software—software which configures input/output points, input/output point data values, and input/output point names to correspond to the input and output devices.

Control Systems—A time-based system for controlling output states of output devices.

Clearly, this type of system set-up is not accessible to a non-technical user. The average homeowner often needs to hire professionals for assistance in configuring home automation systems for routine applications, like lighting or temperature control

### SUMMARY OF THE INVENTION

The invention was created to satisfy the need for a full featured automation system that can be installed, configured and operated by people without the need for extensive training in automation system design, and without the need to be able to write programs using a programming language. In the embodiment, the invention is used to create an automation system that typically contains each of the following components:

Set-up software, allowing users to:
Use a terminal strip and pre-set addresses, to eliminate input/output address configuration.
Associate simple “Names” with each pre-set input or output address location.
Create HMI screens to display each of the input or output points, referencing its Name only.
Enter alarm actions, messages and recipient internet addresses.
Develop rules for the equipment operation using simple drop down boxes, which are pre-configured to implement programming constructs.
Provide connectivity without network design or protocol definitions.
Equipment Operation software or run-time software is provided in the embodiment, with the following capability:
Monitor equipment operation using the HMI screen locally or remotely, from the internet.
Continuously apply operating rules, for automatic control of the equipment.
Switch to “manual” mode to test the response to inputs or force output states.
View alarms on the HMI screen.
Send alarms via e-mail or by telephone.
View the equipment operation using a camera.
View live trends or historical trends of the equipment status or instrument readings.
View customized reports of the equipment operation, based on stored historical data.

All of these capabilities are provided in a small software package installed on a computer, which is part of the installation included in the embodiment. Reliability is also improved by the system simplicity, as explained further below.

According to the invention there is provided an automated control system, which has an electronic device with a microcontroller, set-up and run-time software and a plurality of table data blocks. An input device and an output device are each coupled to the electronic device. The set-up and run-time software configure the table data blocks including an input/output point block, an HMI data block, and a rules variable block. Further the set-up and run-time software and the table data blocks define an operating rule which specifies the action to be taken in response to one of a reading of the input device and a status of the system.

Preferably the set-up software configures input/output points, input/output point data values, and input/output point names to correspond to the input and output devices.

The rules variable block contains one or more records, and each record uniquely defines an operating rule. A variable type may include one a of boolean logic operator, comparison operator and a specially defined operator.
Types of the special logic operator are as follows:
(a) a deadband operator, which allows a logical state to be maintained at values other than the value which triggered the state initially, and
(b) a delay operator, which allows a logical state to be applied at a later time than the time at which the logical state was first triggered.
(c) proportional integral derivative (PID) control,
(d) fail on/off, defining output states, upon triggered by a system failure,
(e) scan time or the frequency of device polling,
(f) flags, which are typically true or false settings,
(g) filters, such as limitations on allowed data changes, or smoothing algorithms, like time averaging,
(h) scaling or fitting a range to a different scale, like 0% to 100%
(i) variables or alternate data storage locations,
(j) over-ride control, providing different control algorithms dependent on different data ranges, a form of nesting,
(k) cascade control, where an output value is used as an input to an operating rule,
(l) ratio control, whereby fixed ratios are maintain among a group of variables, when one of the variables changes value,
(m) feedback control, for example, monitoring of an output and varying inputs to reach a desired output value or output state,
(n) feed-forward control, where a process is better behaved, and inputs are varied to reach a desired output value or output state,
(o) virtual input/output points, that is states or values maintained in a system but not associated with a physical device,
(p) schedules, or time and date based controls, with daily or weekly formats.

The set-up software reads a selected record of the rules variable block and data in the record is used to populate a generic rule, thereby defining a unique rule for the record, based upon variable type or location within the record or a combination of the two.

The set-up software reads the record from the rules variable block and provides one of an English language translation and a non-English language translation for the unique rule, by applying corresponding grammar and syntax rules and using an appropriate combination of pre-defined text strings, the input/output point names and the input/output point data values.

The language translations can be made to result in sentences which have correct syntax and grammar. Alternately, rule translation sentences may be in an abbreviated form, where implicit wording or shortforms are allowed, while an unambiguous meaning of the rule is maintained.

In another aspect of the invention there is provided an automated control system which includes a host computer having set-up software, a data table coupled to said set-up software and configured thereby, and a run-time application coupled to said data table. The automated control system also has a communications module coupled to the run-time application and at least one input device. The set-up software configures a plurality of table data blocks including an input/output point block and a storage data block, the table data blocks being configured by entering input point names and storage parameters. The host computer and the run-time application are thereby enabled to monitor the input devices and store historical data from the input devices. For example, historical data may be recorded for refrigeration equipment, as a part of temperature quality control.

Another aspect of the invention provides an automated control system, which includes a host computer having set-up software, a minimum of one data table coupled to the set-up software and configured thereby, and a run-time application coupled to said data table. This automated control system also includes a communications module coupled to the run-time application and at least one output device. The set-up software configures a plurality of table data blocks including an input/output point block and a rules variable block, said table data blocks being configured by entering output point names and timing rules variables. Thereby, the host computer and run-time application are enabled to perform time based operations to control output states of the output device(s). For example, an irrigation system may be programmed to water an orchard on a daily, weekly and monthly schedule.

Another aspect of the invention provides an automated control system, which includes a host computer having set-up software, a data table coupled to the set-up software and configured thereby, and a run-time application coupled to said data table. This automated control system also includes a communications module coupled to the host computer and at least one input device and output device. The set-up software configures a plurality of table data blocks including an input/output point block and an HMI data block, said table data blocks being configured by entering output point names and HMI data parameters. Thereby the host computer and run-time application are enabled conduct run-time monitoring of input and output values of the input and output device(s) in the automated control system. Complex equipment operations may be monitored in real-time, using the convenience of a computer located in an office, rather than via an old fashioned light board located on the plant floor.

Another aspect of the invention provides an automated control system, which includes a host computer having set-up software, a data table coupled to the set-up software and configured thereby, and a run-time application coupled to said data table. This system also includes at least one of an input and an output device, coupled to an external input/output controller, like a programmable logic controller (PLC). The set-up software configures a plurality of table data blocks including an input/output point block and an HMI data block, said table data blocks being configured by entering input point names and HMI parameters. The host computer and the run-time application are coupled to the external input/output controller, which is in turn coupled to input/output devices, thereby enabling monitoring and control of said input and output device(s).

In another aspect of the invention there is provided an automated control system, which includes a host computer having set-up software, a data table coupled to said set-up software and configured thereby, and a run-time application coupled to said data table. The automated control system also has a communications module coupled to the run-time application and to at least one input/output module, the communications module being operative to provide connectivity between the run-time application and the input/output module. At least one of an input and an output device is coupled to the input/output modules, the one device corresponding to input/output points in the system. The set-up and run-time software configures a plurality of table data blocks including an input/output point block, an HMI data block, and a rules variable block, the table data blocks being configured by entering input and output point names, and data values associated with the input and output point names, to uniquely define desired behaviours of the corresponding output devices based on readings of the corresponding input devices. This aspect of the invention differs from a system with a PLC, in that the run-time software on the host computer interprets rules variables to provide the operating rules that control equipment.

Preferably, making a change in an entry in one of the table data blocks, upon one of manual and automated refresh or reload, results in the same change being made in selected fields in all other table data blocks.

Advantageously, for each input point and associated output point there are predetermined parameters displayed for specification and to assist in setting data entry constraints required to control input/output points.

Data entry constraints are further imposed by a plurality of data entry means selected from the group consisting of:
(a) forms with entry fields, the entry fields including blocks of text,
(b) tables with entry fields, said entry fields being rows and columns,
(c) drop down menus with pre-defined data,
(d) drop down menus with implementation specific data,
(e) radio buttons, check boxes, data selection by group,
(f) a pointing device, selected from the group consisting of a touchscreen pen, mouse, trackball, joystick, cursor keypad, special keypad, or a camera location sensing device,
(g) drag and drop actions, and
(h) slider bars, dials, gauges or knobs.

A rules variable block is structured to correspond directly to the implementation of a generic operating rule. The generic operating rule specifies action to be taken in response to a reading of the input devices.

The rules variable block contains records of variables, each of which are used to uniquely define operating rules, and wherein a variable type includes one of a boolean logic operator, comparison operation and a special logic operator.

Types of the special logic operator are as follows:
(a) a deadband operator, which allows a logical state to be maintained at input values other than a value which triggered the state initially, and
(b) a delay operator, which allows a logical state to be applied at a later time than the time at which the logical state was first triggered.
(c) Any of the other special operators listed above, including:
PID control, fail on/off, scan time, flags, filters, scaling, variables, over-ride control, cascade control, ratio control, feedback control, feed-forward control, virtual input/output points and scheduling algorithms.

One of the set-up software and the run-time application reads through the rules variable block, imports variables from a selected record and then populates a generic operating rule, thereby defining a unique rule for a current record, based upon variable type or location within the record or a combination of both of these factors.

The run-time software applies processing on a cyclical basis. Within each cycle records in the rules variable data block are read sequentially and the unique rule(s) are applied according to current input values of the associated record and thereby create a new output value for the record in a current processing cycle.

Set-up software reads selected records of the rules variable data block, and provides one of an English and a non-English language translation for the unique rules associated with the selected records, by applying corresponding grammar and syntax rules and using an appropriate combination of textual data including pre-defined text strings, the input/output point names and the input/output point data values.

A plurality of the generic operating rules may be implemented. These generic rules may be nested or concatenated and can form a virtually unlimited set of rule structures, as explained further below by means of examples. Corresponding English (or other) language translations are provided to reflect the nesting and concatenation of complex sets of generic rules. Language translations can be made to result in sentences which have correct grammar and syntax. Alternately, rule translation sentences may take abbreviated forms, where the meaning of an operating rule remains unambiguous, but implicit wording or shortforms are allowed.

In yet another aspect of the invention there is provided a method of automated control of equipment, which includes:
(a) providing an electronic device having a microcontroller, set-up and run-time software and a plurality of table data blocks;
(b) providing at least one of an input device and an output device each coupled to said electronic device;
(c) configuring said table data blocks including an input/output point block, an HMI data block, and a rules variable block, said table data blocks being programmable by defining an operating rule which specifies an action in response to one of a reading of said input device and a status.

The configuring step includes configuring input/output points, input/output point data values, and input/output point names to correspond to said input and output device(s).

The rules variable block may be populated with one or more records of data variables. Each record may uniquely define an operating rule, and wherein said variable types includes one of a of boolean logic operator, comparison operator and a special logic operator.

Types of the special logic operator are defined as follows:
(a) a deadband operator, which allows a logical state to be maintained at values other than the value which triggered the state initially, and
(b) a delay operator, which allows a logical state to be applied at a later time than the time at which the logical state was first triggered.
(c) Any of the other special operators listed above, including:
   PID control, fail on/off, scan time, flags, filters, scaling, variables, over-ride control, cascade control, ratio control, feedback control, feed-forward control, virtual input/output points and scheduling algorithms.

Advantageously, the run-time application is separated into a plurality of run-time software components including an input/output server coupled to said communications module and coupled to an internet communications link. The set-up software configures a plurality of tables dedicated to the table data blocks, and also configures a plurality of additional tables, each additional table selected from the group consisting of:
(a) a table of allowed input/output module types,
(b) a table of input/output modules available in one instance of the system implementation,
(c) an image data table,
(d) a table of pre-defined text strings,
(e) an alarm data table,
(f) an alarm action data table,
(g) a scheduling table,
(h) an historical data table,
(i) a reporting data table,
(j) an alarm log data table,
(k) an HMI backdrop table, representing plant layouts or equipment configurations or other visual representations that improve the user interface,
(l) a map definition table, including either facility layouts or geographic maps, and
(m) a map co-ordinate or map overlay table.
In yet another aspect of the invention there is provided a method of automated control of equipment, which includes providing a host computer having set-up software, a minimum of one data table coupled to the set-up software and configured thereby, and a run-time application coupled to the data table and the run-time application having input and output communications links. A communications module is coupled to the run-time application and to at least one input/output module. The communications module is operative to provide connectivity between the run-time application and the input/output module. At least one of an input and an output device is coupled to the input/output modules, with the input and output devices corresponding to input/output points in the system. A plurality of table data blocks including an input/output point block, an HMI data block, and a rules variable block, are configured by entering input and output point names, and data values associated with the input and output point names, as needed to uniquely define desired behaviors of the corresponding output devices based on readings of the corresponding input devices.

The foundation for the present invention is a design, which is based strictly on the use of tables for all configuration and run-time operations. All of the customization for each installation is completed using tables, software that interprets the tables, and uses generic operating rules to manage devices. This makes the system much simpler than other software providing similar functionality. Many other systems use tables in one form or other, such as relational databases or property lists for items like HMI screen elements. All existing systems require programming and other complex methods to develop a fully integrated automation system. The programming may be implemented by the end user, as in PLC based or home automations systems, or it may be implemented by the system developer, as in the HVAC system described in the background. With the present invention, there are no system elements other than simple tables to configure and operate every aspect of the application. In the current invention, there is no user programming, and system developer programming and software maintenance is radically reduced in complexity.

Another important aspect of the table driven approach is that it is possible to enter data in one table and to automatically transfer that data to appropriate fields in other system data tables through a data reload or refresh operation. In this fashion, an end user must only place data in one location and has confidence that this data is reflected elsewhere in their system configuration, reducing human data entry errors. If there is an error in the transfer of data from one table to other system tables on refresh, then this is easy for a developer to detect and correct, due to the simple table structure employed.

The present invention contains a second element which is unique, and adds to the simplicity and power of the invention. The invention uses a rules variable table which contains variables to uniquely define operating rules. The software will read through the table, import the variables from each record, one line (or record) at a time, and then populate a generic operating rule. The resultant unique operating rules perform similarly to operating rules developed using a programming language.

An example of this capability is a rule which causes a light to be turned on when a tank level measurement is below 10%. For this rule, the variables are:
Input Tank Level
Condition <(less than)
Condition Value 10%
Output Light
Output Action Turn On

The input and output values are entered, and the conditions are read to define a unique operating rule. The example uses a very simple rule to illustrate the invention. The software reads each record in the rules variable table, and creates a unique operating rule for that record. Records or lines are read in sequence, creating unique rules that are applied in sequence. In the embodiment, there are many more variables in the table records than there are in the simple example given here. Additional variables include such elements as delay timers, secondary conditions, and times and days when the rule applies. Note that there is no limit to the set of generic operating rules which may be applied to variables, to determine unique operating rules by record. In summary, the present invention contains software that will populate a particular generic operating rule, using records of variables, one line at a time, and then will apply the resultant unique rule by record, to control the equipment to be automated.

Another unique aspect of the present invention, which adds to its simplicity and enables usage by non-technical people, is the Operating Rule Translation feature. With this feature, each operating rule is translated into an English (or other language) sentence, providing an inexperienced user with the ability to read the result of the values being entered when the rules variable table is being set up. In the example above, the English translation reads, “If the tank level is less than 10%, turn on the light.” This type of simple language translation is provided every time a user enters a record in the rules variable table. Thereby, the user can verify that data has been entered correctly. If the translation sentence does not read correctly, and state the intent of the rule, the user knows immediately that an error has been made in the data entry and can easily change the appropriate fields in the record to define the correct rule.

All of the unique aspects of the system described here contribute to system software reliability. It is relatively easy to both program and debug a table driven software package. The programming required for the generic rules and their application is fairly straightforward. The table driven approach also contributes to the ease of troubleshooting and maintenance of the run-time application. The simplicity of these software approaches allows development of a fully featured and complex control system with very little source code, thereby dramatically improving the software reliability.

The system is designed to use sensors and input/output cards that conform to industrial controls standards and have a track record for reliability. The host computer may be readily configured for redundancy or can use a watchdog timer and reset for reliability. All elements of the system are designed for an industrial level of reliability, that is, the host computer configuration, the input/output elements, and the applications software.

As outlined above, the English language translation enhances the earlier capabilities of the invention, by offering simple feedback to the table driven system configuration. In the absence of a table driven approach to a product or system design, the English (or other) language translation feature can stand on its own, as a benefit to any set of logical configuration steps for electronic devices. For example, after setting up a programmable thermostat, the weekend feedback section may read: “On Fridays and Saturdays, set day-time temperature to 70 degrees after 9:00 am and reduce night-time temperature to 60 degrees after 11:00 pm.” A video recorder could be programmed, with the following type of feedback to the user: “Record the show on channel 21, from 9:00 pm to 10:15 pm, on Monday Apr. 4, 2005.” The logical constructs outlined in the current invention make this type of English (or other) language translation accessible to developers skilled in the art.

### BRIEF DESCRIPTION OF THE DRAWINGS

Further features and advantages will be apparent from the following detailed description, given by way of example of a preferred embodiment taken in conjunction with the accompanying drawings, wherein:

FIG. 1 is an overview of the main hardware and software components of the system.

FIG. 2a is a flowchart illustrating the type of screens used and tables created to set-up or configure the installation.

FIG. 2b is a flowchart illustrating the set-up of additional tables that are commonly used in process control or equipment automation.

FIG. 3 is a screen shot from the embodiment showing the means to identify input/output points for the equipment and creates an input/output point table.

FIG. 4 is a screen shot from the embodiment showing how the user configures the HMI screens in a table driven manner and creates an HMI table.

FIG. 5 is a screen shot showing how the user configures alarm actions to be sent when alarm conditions occur during automatic operation of the equipment, and generates an alarm action table.

FIG. 6 is a screen shot of the operating rules variables configuration screen. This includes the variables entered by the user, and an English translation to verify correct entry of the rule parameters, leading to generation of the system rules variable table.

FIG. 7 is a flowchart which illustrates how the equipment run-time software operates.

FIG. 8 is a flowchart of the actions which take place in handling alarms and alarm e-mail notification, as well as the input/output transactions that are used to apply unique rules.

FIG. 9 is a screen shot of a run-time MMI screen which shows images representing various equipment components and status for the equipment being controlled.

FIG. 10 is a flowchart which shows how the operating rules table data is translated into unique operating rules by record.

FIG. 11 is a screen shot of the rules variable table in the embodiment, illustrating the variables used to populate a generic operating rule; the table header corresponds to the generic rule elements.

FIG. 12 is a screen shot of the current state of the data which is transferred from the input/output server, and gives visibility into the instrument and equipment status.

### DETAILED DESCRIPTION WITH REFERENCE TO THE DRAWINGS

In the following description the word input device refers to devices that receive information, such as temperature sensors which sense temperature and provide temperature values. The word output device refers to devices which take an action, such as a heater which can be turned on or off. Finally, the words data entry device refers to slider bards, buttons, drop down menus or other software input devices.

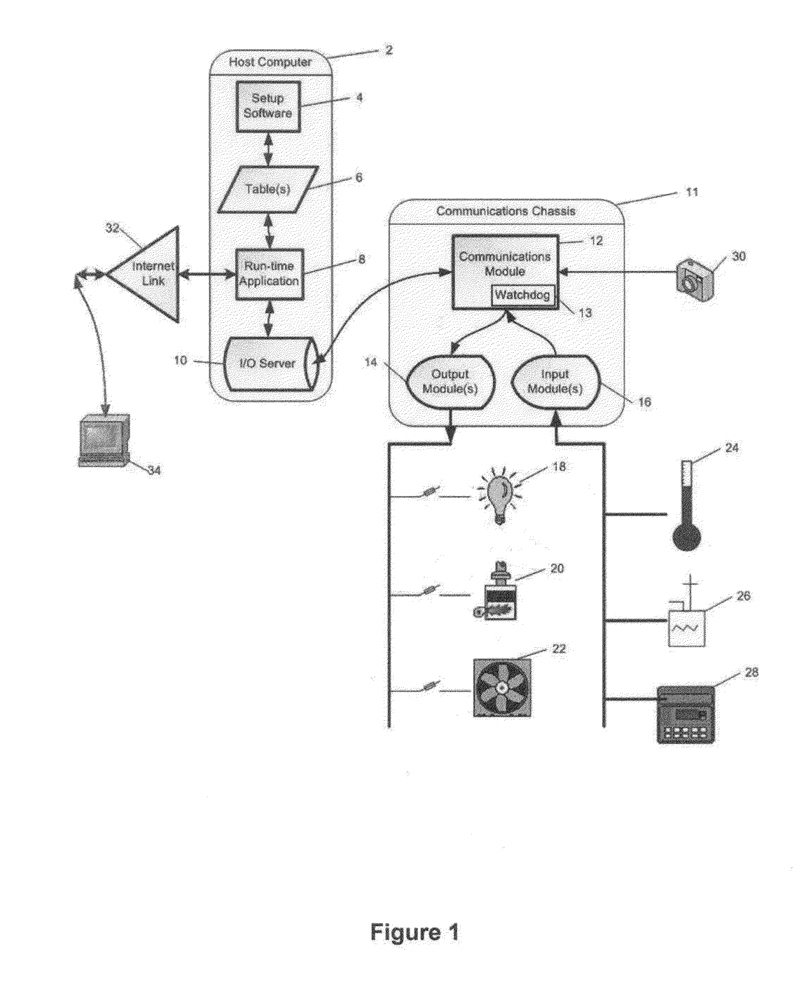

An overview of the hardware and software components of a preferred embodiment of the invention is shown in FIG. 1. At the center of the diagram is a communications chassis 11 containing input/output modules 14, 16 that incorporate terminal strips, where each input and output device is connected. Examples of typical input devices are a temperature sensor 24, fluid level monitor 26, or other instrument 28 capable of providing data values, and examples of output devices are a light 18, heater 20, or fan 22. Outputs can be discrete, to turn equipment on or off, or may be analog, to control motor speed, for example. The input and output devices are not limited to the examples shown. Any industry standard input or output device, or any other such device connected via an appropriate interface adaptor, may be used in an embodiment of the current invention.

A commercially available communications module 12 resides within the communications chassis 11, for connectivity between the input/output server 10 and the input/output modules 14, 16. The communications module provides signal digitization and scaling, serial protocol to ethernet conversion, and an ethernet adaptor, to effect connectivity. The communications module also contains a watchdog timer 13, that polls the host computer 2 for a heartbeat signal. If the heartbeat is absent, the watchdog 13 can power-down the host 2, causing a system reboot and restarting the run-time application, resolving operational problems in many cases. A digital camera 30 can be used to feed images to the system via the communications module 12. Note that all of the communications module 12 functions are commercially available or simple to implement. Further, the end user of the system has no interaction with the communications module 12 capabilities described here.

The run-time software or run-time application 8 reads static data tables 6 which are configured using the system set-up software 4 and generates corresponding run-time data tables 6. Set-up software 4, tables 6, the run-time software 8 and the input/output server 10 all reside within a host computer 2. The run-time application 8 has a standard internet communications link 32, which can send and receive data from a remote personal computer 34. The run-time application 8 can send alarm e-mail out over the internet link 32 to a remote computer 34. Any remote computer 34 can also access the set-up 4 and run-time application 8 within the host computer, via the internet link 32.

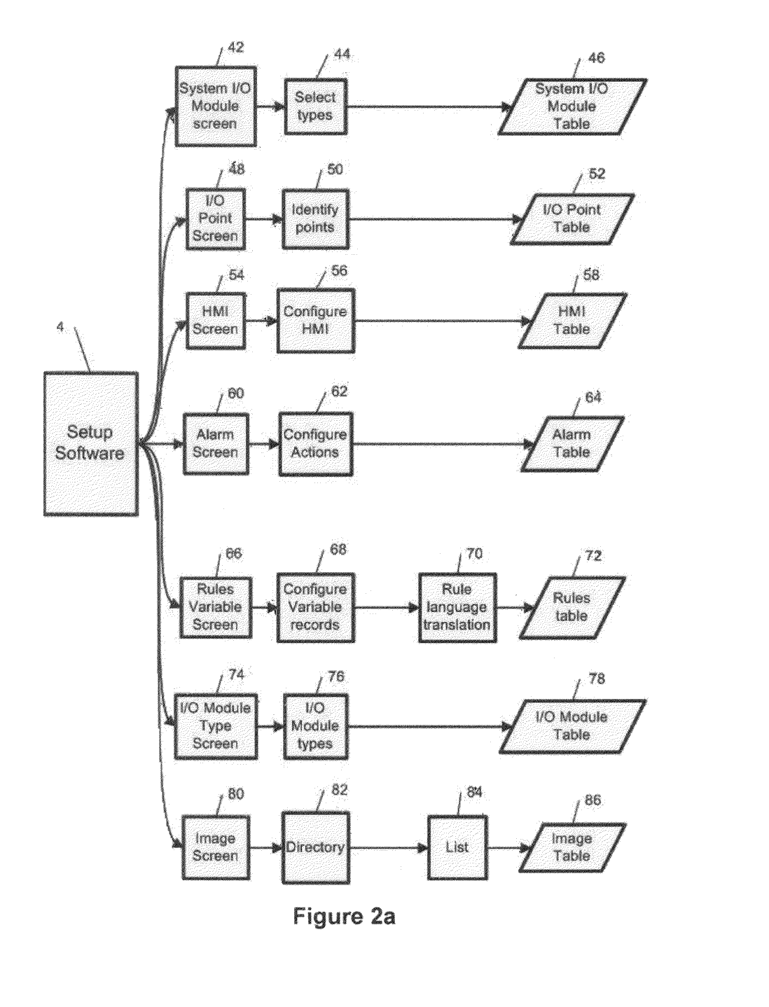

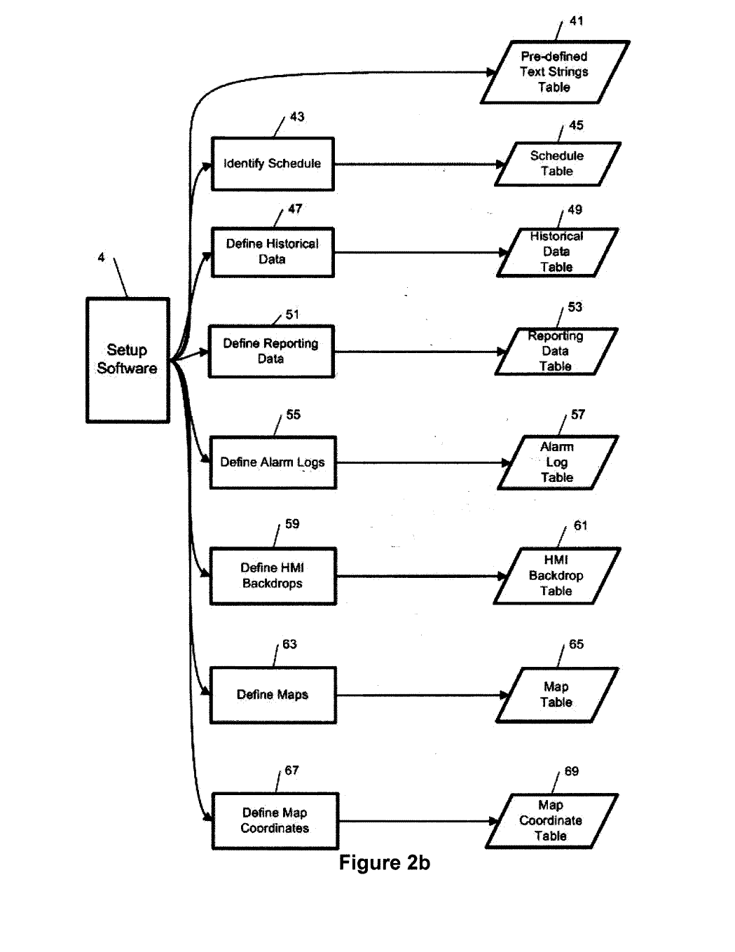

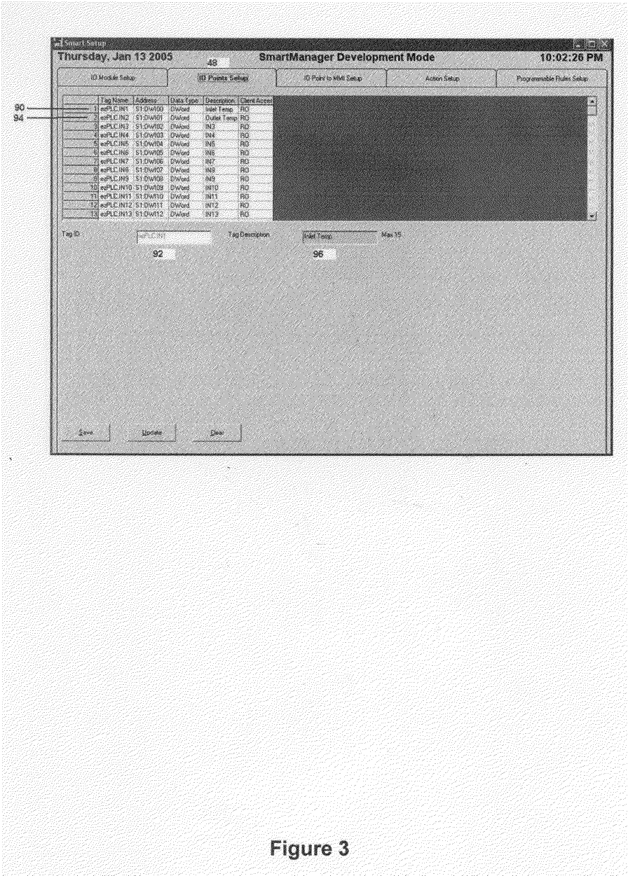

The set-up or configuration software 4 functions are summarized in FIG. 2a and expanded upon by user interface screen shots in FIG. 3 through FIG. 6. Factory installed functions do not have an end user interface; these functions are implemented using hidden screens. Factory installed functions include access to a screen for images 80, which allows storage of images in a directory 82. The directory 82 produces an image list 84 which then defines an image data table 86. The image table 86 is accessed by the HMI set-up screen 54. Another hidden screen 74 is used to define the type of input/output modules available 76 in the system and store these in a general input/output module table 78. That input/output module table 78 is accessed by another hidden screen, the input/output module set-up 42. The number and type of input/output modules for a particular installation are set-up by selecting module types 44 and placing them in an implementation specific input/output module table 46. The latter input/output module table 46 is accessed by the end user input/output point screen 48.

Remaining set-up screens are accessible by the end user. Individual set-up screens are selected using tabs on the setup application 4. In summary, these are as follows: An input/output point set-up screen 48 is used to identify or name all input/output points 50 and place the resultant name data in an input/output point table 52. The HMI set-up screen 54 is used to configure a number of HMI screens 56 and place the resulting configuration information in the HMI data table 58. The alarm set-up screen 60 is used to configure alarm actions 62 and place the results in an alarm action data table 64. The rules variable set-up screen 66 is used to configure variable records 68, each of which is interpreted as a unique rule. Unique rules are verified by an English language translation function 70. Set-up results are stored in a rules variable table 72. The group of all data tables 46, 52, 58, 64, 72, 78, 86 is included in the data tables 6 in FIG. 1, which are later accessed by the run-time application 8. The run-time application 8 generates corresponding run-time tables 6. Note that in future, the embodiment may include additional set-up screens and configure new types of data tables, like an historical data table, to expand upon the current system functionality for equipment automation or other applications. Such expansion is well within the capability of someone skilled in the art, given the concepts defined in the current embodiment of the invention. Basic set-up functions have been identified in FIG. 2a, but the elegance of the table driven approach of the current invention is better described by the screen shots in FIG. 3 through FIG. 6.

FIG. 2b illustrates the set-up of additional tables that are commonly used in process control or equipment automation. Any combination of these tables may be used within embodiments of the current invention. As shown in FIG. 2b, the set-up software 4 allows access to individual set-up screens, with the following functionality and contents:
(a) a table of pre-defined text strings 41,
(b) identification of schedules 43 and creation of a scheduling table 45,
(c) definition of historical data 47 to be recorded and creation of an historical data table 49, that is, defining data storage parameters over a period of time,
(d) definition of reporting data 51 options and creation of a reporting data table 53,
(e) definition of alarm logs 55 to be recorded and creation of an alarm log table 57,
(f) definition of HMI backdrops 59, such as plant layouts or equipment configurations, and creation of an HMI backdrop table 61,
(g) definition of maps 63 to be used in the system and creation of a map table 65,
(h) definition of map co-ordinates 67 or overlays and creation of a map co-ordinate table 69.

FIG. 3 illustrates a screen shot of the input/output point set-up page, accessed by the input/output point set-up tab 48 in the set-up software application 4. Note that input/output points are commonly called tags. By clicking on a line in the table 90, a factory preset input/output point address or tag identifier (tag ID) 92 appears below. The user enters a corresponding tag description 96, or simple Name, like “Inlet Temp”, to complete an input/output point definition. Another line is highlighted 94 and a second tag descriptor 96, or simple input/output point Name, like “Outlet Temp” is entered. All input/output points included in the system are named in this fashion and the results are stored in the input/output point data table 52. A system refresh function populates all system data tables 6 with the input/output point data fields entered here.

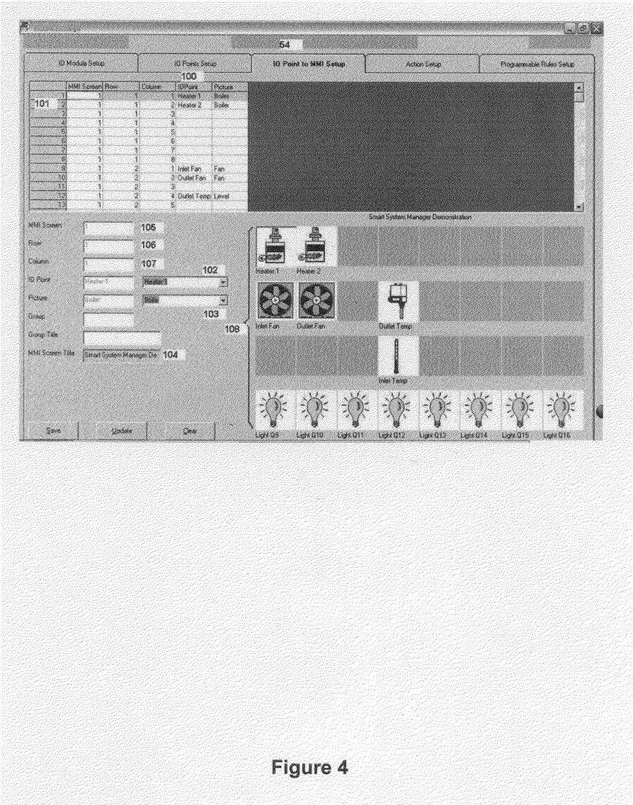

This system refresh and data sharing capability of the system, as well as the ease of a table driven approach to generating run-time HMI screens, is illustrated in FIG. 4. In the example, the HMI is called MMI, for man-machine interface. The I/O Point to MMI set-up page 54 is accessed from the set-up software 4. Note that all defined input/output points are listed in a drop down menu 102, using their simple Names, like “Heater 1”. An appropriate image for that point is selected from the image drop down menu 103. Initial MMI set-up includes: Defining an MMI screen number 105, and the row 106 and column 107 location of the input/output point image to appear on the run-time screen. A preview of that run-time screen appears in the array 108 in the lower right quadrant of the screen. The image is shown in the appropriate row 106 and column 107 for the current input/output point 102. Likewise, the MMI array 108 is represented on a point-by-point basis in tabular format at the top of the screen. This is illustrated in the second line 101 of the table, which defines “Heater 2” as a “Boiler”, on MMI screen “1”, at row “1”, column “2”. Note that any number of MMI screens can be created. For each of the screens, the user applies the drop down box 104 to enter the title for the screen.

The entire MMI screen creation is highly intuitive and provides good visual feedback to the user. The simple table driven approach for data entry, transfer of known data from one type of setup table to all others via refresh, and use of resultant HMI data tables 58 during operations, are extremely powerful concepts, which do not presently exist in the field of equipment automation. The layout and content of the MMI screens may vary in future, while remaining entirely consistent with these concepts.

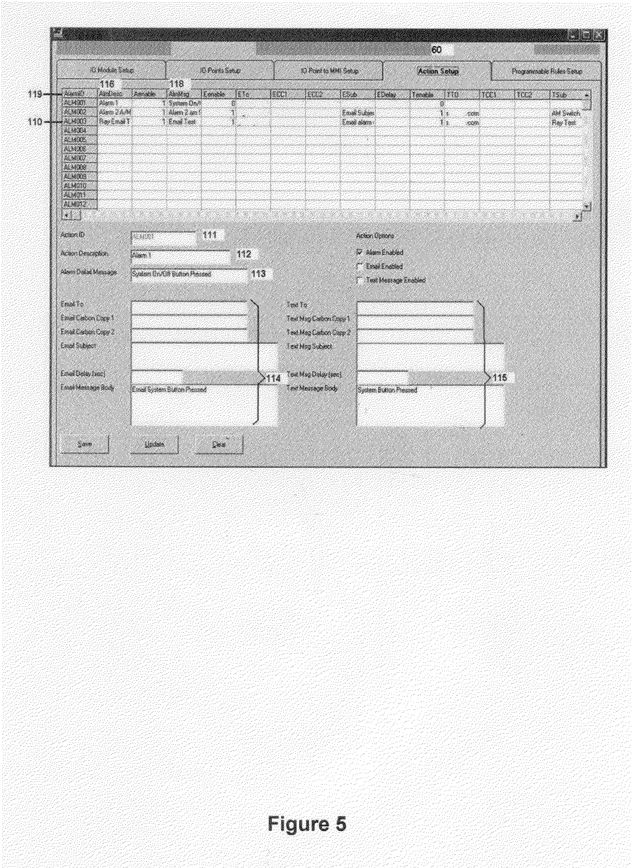

FIG. 5 illustrates the table driven approach to alarm actions. Action set-up 60 is accessed from the set-up software 4. Clicking on a line 110 of the alarm set-up causes known data to appear in all fields on the screen. On initial set-up, one starts with the alarm action identifier (ID) 111 and enters descriptive data, like the alarm name 112 and alarm detail message 113. As an example, when the user enters the alarm detail message 113, it will appear in the tabular view above under column heading 118. E-mail specifications 114 for that alarm action identifier 111 are then entered. Text specifications 115 are entered for telephone or pager messages. For confirmation, all relevant data is automatically listed in the appropriate row 110 and column header 119 location. For example, data entered for a particular line 110, in the alarm description box 112, will appear in the appropriate row in the alarm description column 116 within the header 119. Set-up results for all alarm definitions are stored in the alarm data table 64. Note that the system concept of tabular input is maintained in the alarm action set-up.

During operation of the run-time application 8, the information from the alarm setup enables two important functions. Alarm actions appear as defined on the MMI screens. Alarm notifications, with associated text 112 and alarm details 113 are sent to the recipient specified for e-mail 114 or phone text messages 115. Note that alarm usage and notification functions may evolve in future. These will follow the table driven approach outlined herein and further embodiments remain within the ability of practitioners skilled in the art.

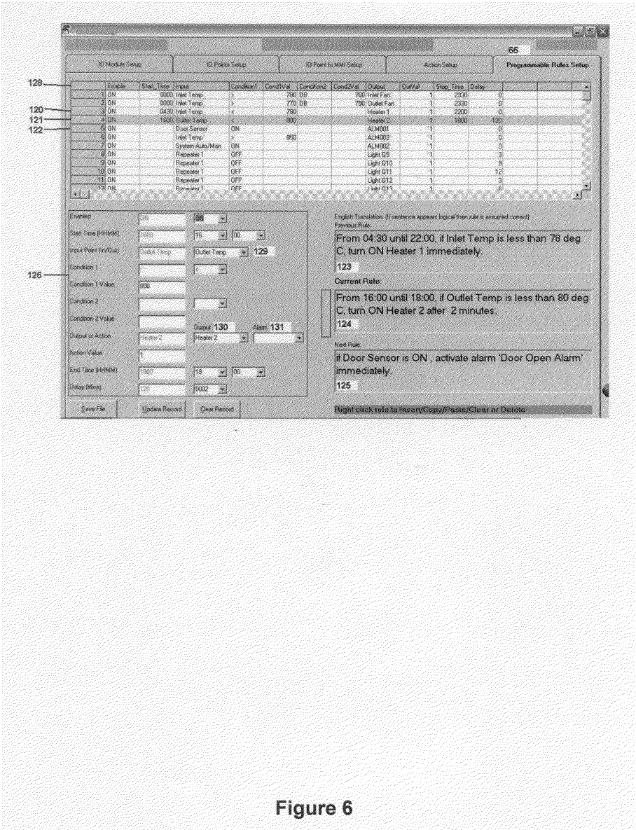

Two important concepts of the current invention are captured in the current embodiment as shown in FIG. 6 on the set-up of system rules. First, the entry of rules variables is table driven and the application of those rules is also table driven. Second, the structure of a generic rule which is applied to the rules variables is captured in an English (or other) language translation.

The operating rules set-up screen 66 is accessed via the set-up software 4. As shown in FIG. 6, the variables entered on three lines 120, 121, and 122 are translated into English language sentences in three corresponding boxes 123, 124, 125, when the user highlights the middle row 121. As before, known data, for input/output points in the selected row 121, appears automatically in the menu region 126 in the lower left quadrant. For example, input points appear in one drop down menu 129 and output points appear in a second drop down menu 130. Input and output points are selected and remaining data fields are completed in the data entry area 126. If the user is configuring an alarm, then the user will select the Alarm drop-down 131, instead of the Output drop-down 130. Setup results are stored in the operating rule variable table 72.

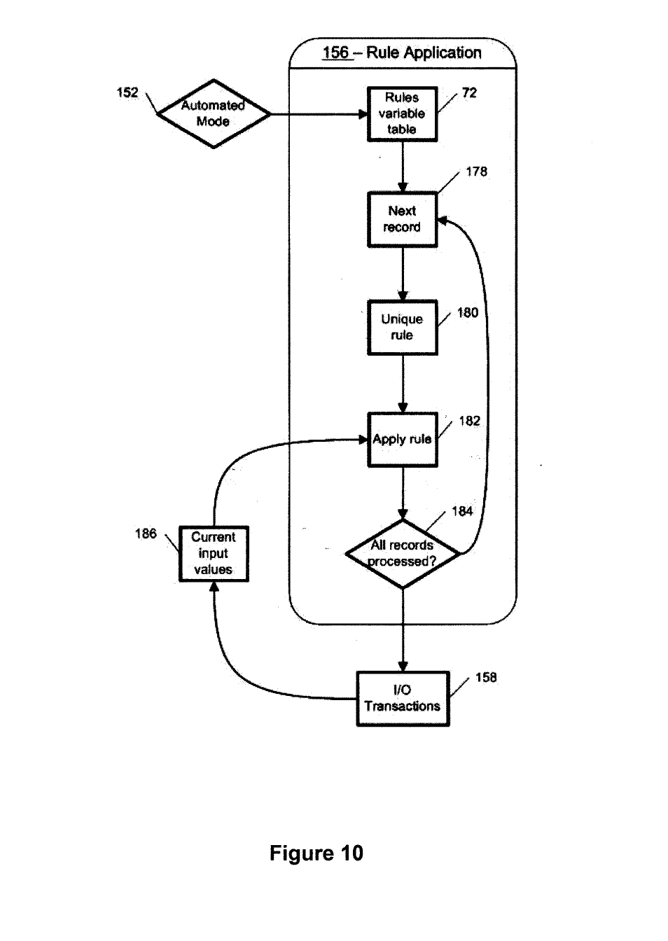

For ease of verification, variables are stored in the table at the top of the screen, where the data entry fields are shown under appropriate header 128 columns at the correct row 121. The elegance of the system is enhanced by the next function. Once rule variables are entered, they are translated into English language sentences 124. Later, the rules variables on each line or each record, are used to apply unique rules by record, to the run-time system. Rule application is an important concept in the current invention, and it is fully explained by some examples below, and in the rule application steps shown in FIG. 10.

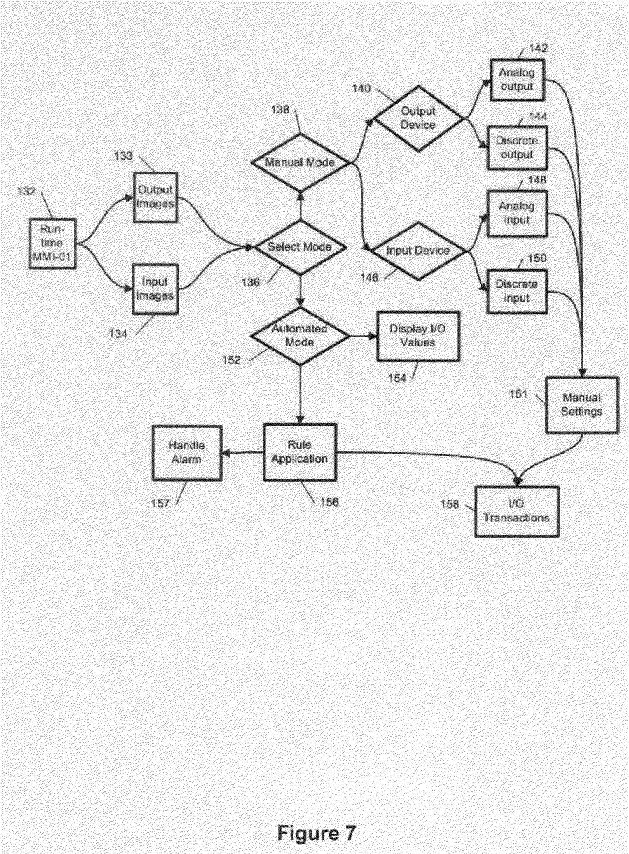

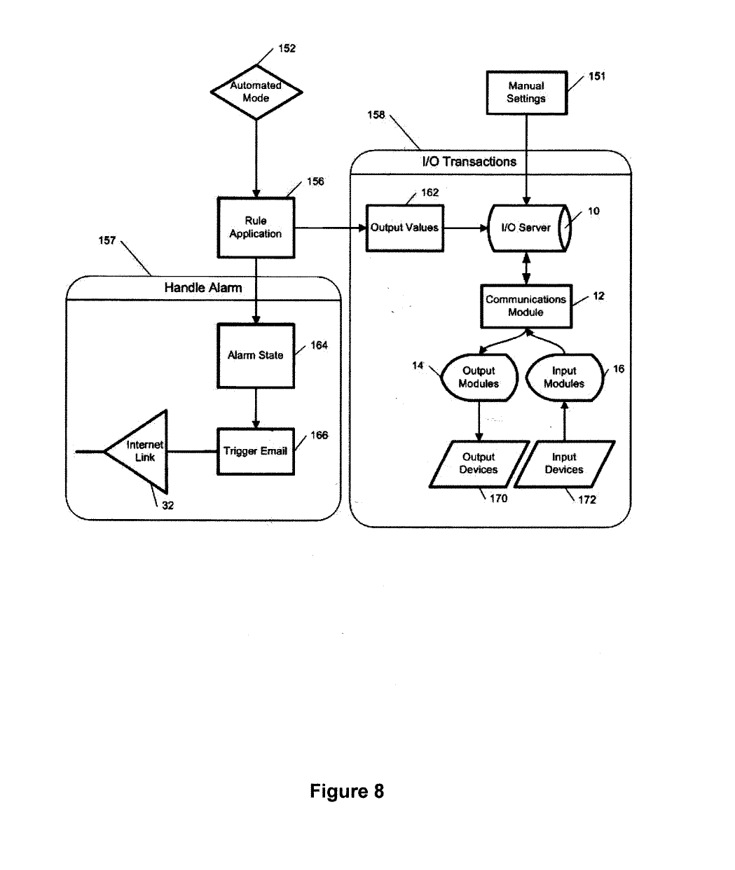

FIG. 7 shows the run-time functions of switching from automatic equipment control to manual control. Additional run-time functions of rule application 156 are shown in more detail in FIG. 10 and the details of Alarm and input/output transaction handling 158 are shown in FIG. 8.

Run-time operation in FIG. 7 begins with selection of one MMI screen 132, which shows both input 134 and output 133 images. Clicking on an image allows selection 136 of automated mode 152 or manual mode 138 operation. In manual mode 138, the run-time application will determine whether the user has selected an output device 140 type or an input device 146 type. If it is an output device 140, the application will determine whether it is an analog type 142 or a discrete type 144. The latter has values “1” for “on” and “0” for “off”. If an input device 146 is selected, it may again be analog 148 or discrete 150.

Manual operation allows a user to set an analog 148 or discrete 150 input value and test the resultant system response. Alternately, the user may wish to force manual output behavior of either an analog type 142, like a motor speed control, or a discrete type 144, like starting a boiler. Whatever the manual mode input/output point setting, it is enabled through the input/output handling 158 functions of the system, which are outlined in FIG. 8. All analog and discrete manual input/output settings 151 are sent as a group to the input/output transaction stage 158.

If for a particular input/output point image on an MMI screen the automated mode 152 is selected, the system will cause the current input/output values to be displayed 154 on the MMI screen and apply the appropriate rules 156 for input/output points. After rule application 156, messages and outputs are sent to the alarm handling 157 and input/output transactions 158 as needed. These functions are expanded upon in FIG. 8. Note that the system remembers the current setting of manual or automated operation of all input/output points and processes the application of rules for all automated points, unless the user overrides that state with selection of a manual setting 136. Different colors are used to flag current status, as described below.

FIG. 8 shows alarm and input/output handing functions of an embodiment of the invention. After rule application 156 the system has new output values 162 or alarm states 164. An alarm state 164 may trigger previously defined e-mail 166 or phone or pager messages, that are automatically sent out over an internet link 32. Rule application 56 may also cause output values 162 to be transmitted to the input/output server software 10. Alternately, the input/output server 10 may receive data from any one of the manual mode settings 151, which will override automated outputs. On a regular cycle, like one second intervals, the input/output server collects information from the input/output modules 14, 16 and the system updates the application of all rules 156. Changes in manual settings or automated output settings are then driven (within the cycle), to the input/output modules 14, 16 and to the input/output devices 170, 172 connected to the system. Input/output devices 170, 172 are of the type 18, 20, 22, 24, 26, 28 shown in FIG. 1, or any other type.

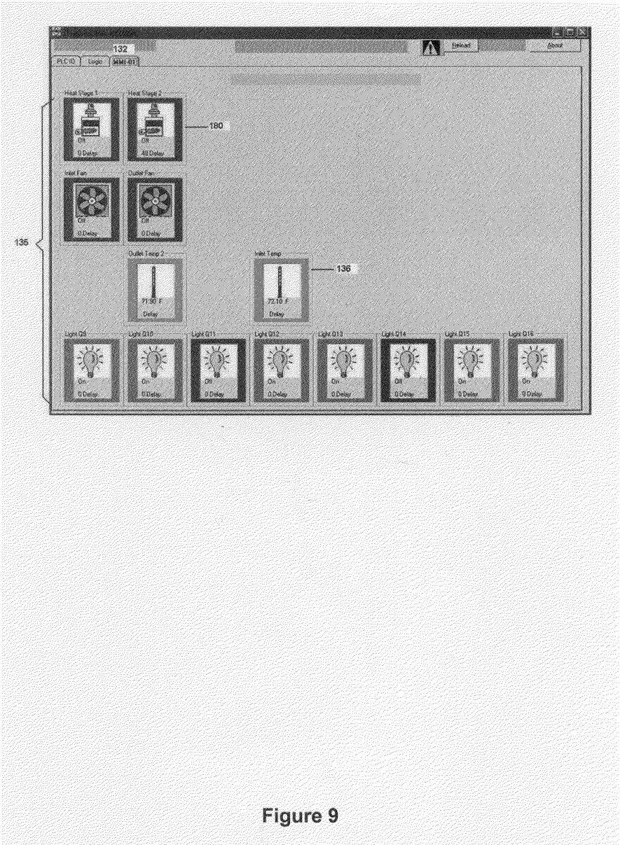

FIG. 9 shows run-time MMI screen number one, which is selected from the run-time application 8 by an MMI tab 132. The array 135 shown on the screen is similar to the array 108 created on set-up, from FIG. 4, but it has added information, on run-time data values and input/output point states. The user can click on any image 136 to enable manual or automated control. A yellow status indicator is used to highlight the input/output points in the MMI that are currently in manual control mode. These are distinguished from points in automated control mode, which are highlighted as red for “inactive” and green for “active”. Input images are highlighted in blue and display the value of the current input reading. Note that the input/output point images include visual representations of data associated with points. One point 180 on the screen is “Heater 2”, with a “Boiler” image, its current status is “off”, and it will only switch “on” after a “48 (second) delay” in the change of conditions controlling its behavior.

FIG. 10 is an overview of the steps taken to apply rules in the system for all input/output points operating in automated mode 152. Processing begins with access to the rules variables table 72. If there are N lines or records in the table 72, then these are processed in sequence from 1 to N (n=1, . . . , N). Within the processing cycle, a particular record, “n”, is read. The data from that record is used to populate a generic operating rule, creating a unique rule for line “n” 180. Appropriate data are read from the current values in the run-time input/output point table 186 and the unique rule 180 is applied. The program checks to see if all N records of the rules variable table 72 have been read 184. If not, the program returns to read another record 178. When all records are processed for the current cycle, output values are passed to the input/output transactions sub-system 158. At the end of each rules application program cycle, the input/output transactions sub-system 158 reads all of the new input/output point values and updates the run-time input/output point table 186. The processing cycle is applied on a continuous basis.

Some examples of the application of generic algorithms are now presented, to illustrate:
How the current invention may be implemented by someone skilled in the art.
That the content and structure of potential algorithms is virtually unlimited and that a plurality of generic rules may be implemented in the current invention.

Different generic algorithms are used in the pseudo-code of the Algorithm section of each example. The algorithm in each example is populated with current input point values, leading to a new output point value for the current processing cycle.

The invention includes the use of both discrete (On/Off) and analog (numeric value) input point types. Looking at the header 128 and row 3 120 of the Rules setup screen in FIG. 6, it is noted that the input point called “Inlet Temp” is an analog point with Condition 1 set as the boolean logic operator and comparison operator “less than” (<), and Condition 1 Value set as the numeric value “78” (degrees). As shown in row 5 122, a discrete input point has Condition 1 set as either “On” or “Off”, and a Condition 1 Value that is undefined or “blank”. The algorithm checks to see if Condition 1 is either “On” or “Off” and if that is true, the point is treated as discrete by the algorithm. Otherwise, the input point is treated as an analog point, for which the algorithm uses the Condition 1 operator (typically “>” or “<”) to compare the current value to the Condition 1 Value for that point.

The previous paragraph describes data types and logic conventions used in a current embodiment of the invention. Alternate embodiments may use any other combination of conventions for input of numeric values or logical operators, and still remain well within the scope of the current invention. For instance, in the fourth algorithm example herein, a logical operator called “DB” or “Deadband” is defined for one of the functions commonly required in equipment control. One of various possible implementations of the Deadband operation is explained below. Such constructs are well within the capability of someone skilled in the art of equipment automation or industrial control.

In the current embodiment of the invention, the output point in each record may be either an alarm or a control point, but not both. The data definition section 126 in FIG. 6 distinguishes between the two. Only Control points are listed in the Output drop down menu 130 and only Alarms are listed in the Alarm drop down menu 131. A check is performed by the algorithm to determine the type of output, during rule application 156 of FIG. 8. If the output point is an alarm, e-mail is sent 164, 166, and if the output point is a control point, then the output state 162 is sent to the equipment via the input/output server 10.

It is obvious that in future embodiments, both types of outputs may be allowed at the same time, for the same record or operating rule.

In the current embodiment, output states and test variables are initialized as zero at the start of each processing cycle. Test conditions are applied by the algorithm and if all tests are satisfied, the output state is “1”. While this is an elegant approach to the logic implementation, it is only one of many forms that the generic rule might take, in terms of specific software implementation. In the algorithm examples below, Output Result=0, Test 1=0, Test 2=0, Test 3=0, and so forth, at the start of each processing cycle. Other variables are initialized as zero, like Alarm Check=0. In the algorithm examples, values “1” and “0” correspond to “On” and “Off”, respectively.

In the tables below, the Variable list corresponds to the column titles in the header row 128 of the operating rules set-up screen, shown in FIG. 6.

In the current embodiment of the invention, two input points are combined via a logical AND operation to determine the output result, but in example 2, this has been replaced with a logical OR operation. All variations in logic operators are within the scope of the invention.

TABLE I
Algorithm Example 1
Time Based Example

| Variable or Column | Name or Value |
|---|---|
| Enabled | Yes |
| Start Time | 7:00 pm |
| Output Point | Room 1 Lights |
| Output Value | 1 |
| End Time | 8:00 am |

Translation:
“From 7:00 pm to 8:00 am
turn on Room 1 Lights immediately.”
Algorithm

| | |
|---|---|
| • | Enabled Test: |

```
  If “Enabled” = 1,
  then Test 1 = 1
```

| • | Time Test |
|---|---|
| | If ((“Time” > “Start Time”) AND |
| | (“Time” < “End Time”)), |
| | then Test 2 = 1 |
| • | Take output action |

“Output Result” = Test 1 x Test

2

= 1 x 1 = 1

If “Output Result” = 1,

then Write “Output Value” to

“Room 1 Lights”
An alarm check step has been omitted from this example for simplicity.

TABLE II
Algorithm Example 2
Logical OR Example

| Variable or Column | Name or Value |
|---|---|
| Enabled | Yes |
| Start Time | 9:00 pm |
| Input Point 1 | Front Door Sensor |
| Condition 1 | On |
| Condition 1 Value | (blank) |
| Logical Operator | OR |
| Input Point 2 | Back Door Sensor |
| Condition 2 | On |
| Condition 2 Value | (blank) |
| Output Point | Door Alarm |
| Output Type | (alarm) |
| Output Value | 1 |
| Delay | 0 |
| End Time | 6:00 am |

Translation:
“From 9:00 pm to 6:00 am,
if Front Door Sensor is on, OR
Back Door Sensor is on,
activate Door Alarm immediately.”
Algorithm

| | |
|---|---|
| • | Enabled Test: |

If “Enabled” = 1,
then Test 1 = 1

| | |
|---|---|
| • | Time Test |

If ((“Time” > “Start Time”) AND

(“Time” < “End Time”)),

then Test 2 = 1

| | |
|---|---|
| • | Input Type Tests |

If (″Condition 1″ = ″On″ OR ″Off″),

then

process as a discrete point (1 or 0)

| | |
|---|---|
| • | Input Condition Tests |

If (“Input Point 1” = 1) OR

(“Input Point 2” = 1), then Test 3 = 1

| | |
|---|---|
| • | Is Output an Alarm or a Control point? |

If (″Output Type″ = ″alarm″)
then Alarm Check = 1

| | |
|---|---|
| • | Take output action. |

“Output Result” =Test 1 x Test 2 x Test 3

= 1 x 1 x 1 = 1

If “Output Result” = 1,

then (If (″Alarm Check″ = 1)

Activate Alarm (″Door Alarm″)

else (Write ″Output Value″ to

″Output Point Name″)

TABLE III
Algorithm Example 3
Logical AND Plus Delay Example

| Column or Variable | Name or Value |
|---|---|
| Enabled | Yes |
| Start Time | 8:00 am |
| Input Point 1 | Soil Moisture |
| Condition 1 | < (less than) |
| Condition 1 Value | 2% |
| Logical Operator | AND |
| Input Point 2 | Wind Speed |
| Condition 2 | < (less than) |
| Condition 2 Value | 30 mph |
| Output Point | Irrigation Valve |
| Output Value | 1 |
| Delay | 30 minutes |
| End Time | 11:00 am |

Translation:
“From 8:00 am to 11:00 am, if Soil Moisture
is less than 2%, AND Wind Speed is less
than 30 mph, turn on Irrigation Valve after
30 minutes.”
Algorithm

| • | Enabled Test: |
|---|---|
| | If “Enabled” = 1, then Test 1 = 1 |
| • | Time Test |

If ((“Time” > “Start Time”) AND
(“Time” < “End Time”)), then Test

| | 2 = 1 |
|---|---|
| • | Input Condition Tests |

If (″Input Point 1″ < 2%) AND

(″Input Point 2″ < 30 mph) Test

| | 3 = 1 |
|---|---|
| • | Delay Test |

If (Test 1 x Test 2 x Test 3) = 1,

then Perform(Delay Timer

countdown),

else Delay Timer = 30

If (″Delay Timer″ = 0), then Test

| | 4 = 1 |
|---|---|
| • | Take output action |

```
  “Output Result” =
  Test 1 x Test 2 x Test 3 x Test 4
  = 1 x 1 x 1 x 1 = 1
```

If “Output Result” = 1,
then (Write ″Output Value″ to

″Irrigation Valve″)

TABLE IV
Algorithm Example 4
Deadband Condition Example

| Column or Variable | Name or Value |
|---|---|
| Enabled | Yes |
| Start Time | 6:00 am |
| Input Point 1 | Hot Water Tank Temp |
| Condition 1 | < (less than) |
| Condition 1 Value | 80° |
| Logical Operator | AND |
| Input Point 2 | Hot Water Tank Temp |
| Condition 2 | DB (deadband) |
| Condition 2 Value | 90° |
| Output Point | Hot Water Tank Heater |
| Output Value | 1 |
| Delay | 0 |
| End Time | 7:00 pm |

Translation:
“From 6:00 am to 7:00 pm, if Hot Water Tank
Temp is less than 80° AND until Hot Water Tank
Temp reaches 90°, turn On Hot Water Tank
Heater.”
Algorithm

| | |
|---|---|
| • | Deadband flag, DBFlag = 0 |
| • | Enabled Test: |

If “Enabled” = 1, then Test 1 = 1

| | |
|---|---|
| • | Time Test |

If ((“Time” > “Start Time”) AND

(“Time” < “End Time”)), then Test 2

| | = 1 |
|---|---|
| • | If (″Condition 2″ = ″DB″), Apply (DB |
| | Rules) |
| • | DB Input Test Conditions |

If (“Input Point 1” < 80 °),

then Test 3 = 1 AND DBFlag = 1

Else

if (DBFlag = 1) then

If (″Input Point 2″ < 90 °), then

Test 3 = 1

else Test 3 = 0 AND DBFlag = 0

else Test 3 = 0

endif

| | |
|---|---|
| • | Take output action. |

“Output Result” = Test 1 x Test 2 x

Test 3

= 1 x 1 x 1 = 1

```
  If “Output Result” = 1,
  then (Write ″Output Value″ to
```

″Hot Water Tank Heater″)

An Alarm check and Input Type check have been omitted from examples 3 and 4, for simplicity. Other checks are also applied, to complete the generic form. For example, if an input point and its conditions are undefined or “blank”, the algorithm will skip the associated test conditions. Such an approach minimizes code stream variants, and is within the skill set of a competent software developer.

Based on the algorithm examples given, it is evident that differing structures and differing degrees of complexity may be present in the generic rules of the current invention. In particular:
The generic rule may vary within a single system implementation or the generic rule may vary across different system implementations
There is no theoretical limit to the form or structure of generic rules.
   Rules may be nested or concatenated.
   Extensive rules may be handled by multiple records and multiple sequential English language translations,
   and optional or nested rules may be handled as inserted phrase translations

Given the disclosures of the current invention, creation of a new generic rule, and providing an English (or other) language translation of that rule, is well within the ability of someone skilled in the art of process control, partly because the tabular approach makes rule creation easy. Therefore all new generic rules are within the scope of the expected embodiments of the current invention. The concept that all new generic rules and all generic rule structures are encompassed in the current invention is captured in the statement that a plurality of generic rules may be implemented in the current invention.

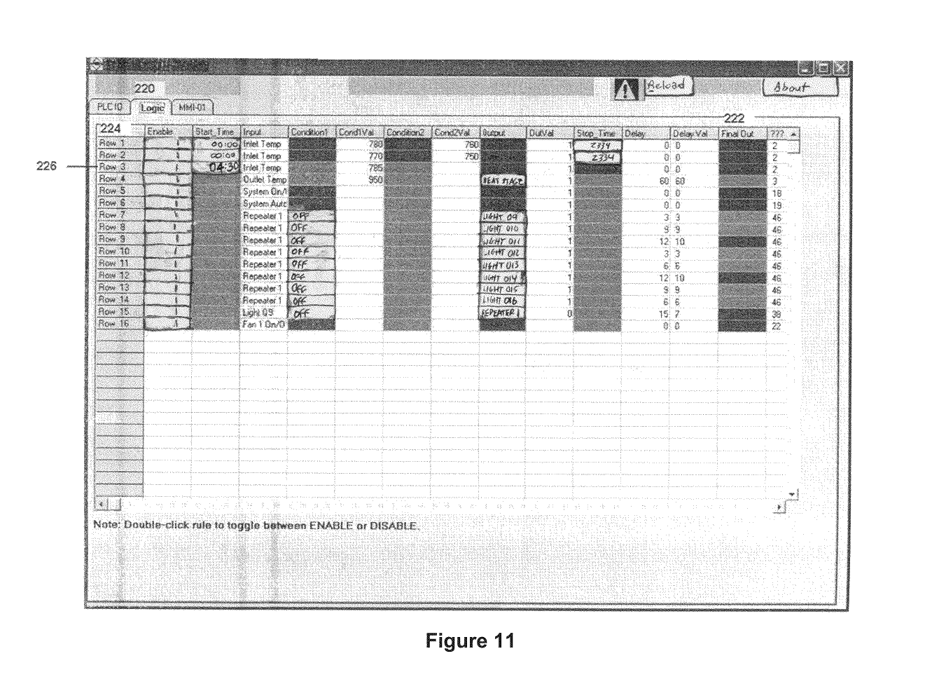

FIG. 11 is a screen shot of the run-time application of rules. All of the of the rules variables that were setup using the screen in FIG. 6 reappear on the run-time screen. It is accessed using the Logic tab 220 in the run-time application 8. In addition to all of the rules variables that were set up initially, there is also a column of final output values 222, which shows the current state of all rule outputs. There is one final output for every row 226. FIG. 11 shows the set of all rows onscreen, and reflects the unique rule application for all records, in the current processing cycle. For larger systems, additional screens may appear, to cover all of the run-time application of rules.

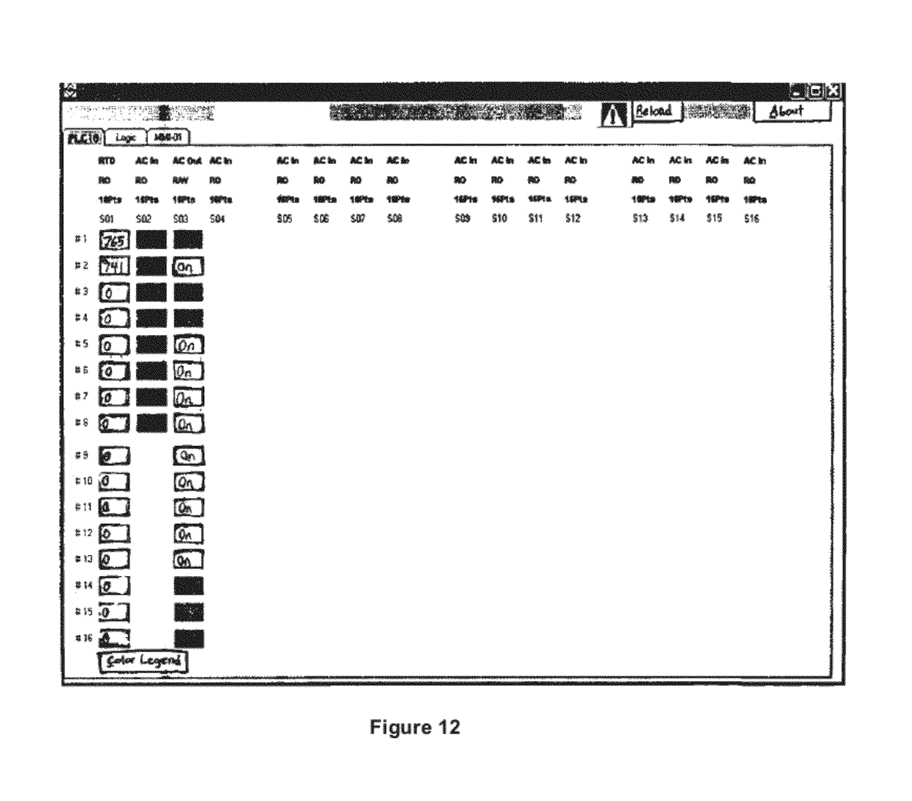

FIG. 12 provides feedback to the user on the current status or value of all input/output points. It is useful in confirming correct wiring, configuration and equipment operations.

The preferred embodiment described above illustrates the structure of the invention, notably three main unique capabilities which all contribute to the simplicity of the automation invention. The use of simple structured tables for configuration and data input consistency across tables, via a refresh function, is of value in its own right. This basic functionality is expanded upon significantly by the use of generic rules and a table driven structure during operation. The overall system constructs are extremely easy to develop, setup, maintain and operate. The English translation feature enhances the other features. In addition, it could be of benefit to many existing electronic devices, such as programmable thermostats found in homes and commercial buildings. Thermostats with weekly schedules are confusing and tedious to program, and some users are not confident of the setup until they witness the operation of the thermostat over a week. An English translation of the setup program would be easy to provide and overcomes current deficiencies in the state-of-the art. Many other set-up applications could benefit from English language translation. Alarm clock set-up and video recording set-up are just two more of the many examples of the utility of this aspect of the current invention; the list of applications that would benefit is extensive.

In addition to equipment control, the invention can be used in many other variations where input information or output information can be monitored electronically. The system can be used as a security system for a facility. The sensors are connected as switches (discrete inputs), and the system can send alarms if the security is breached. Card readers can be attached for secure door access. Cameras can be used to monitor general activity, or motion, or events triggered by alarms. All elements of proprietary security systems can be implemented with relative ease, by means of the current invention.

As a data recording and trending tool, the system has many benefits, since the implementation can be done easily and information becomes available over the Internet. As well, there is no technical training required to complete an installation. In addition to just monitoring, alarms can be transmitted when conditions such as temperature limits are exceeded.

The most obvious use for the invention is equipment automation or equipment operational monitoring and control. The three unique aspects of the invention all contribute to overall simplicity. The features of table driven set-up, use of generic rules in operations, and English language translations, when used in combination, enhance one another for maximum benefit. Applications could include irrigation systems, greenhouse control, building heating, ventilation and air conditioning control, and any other system containing electrically operated equipment. The benefits of the system simplicity include, but are not limited to, ease of troubleshooting, ease of maintenance, and ability for non-technical persons to configure and operate the system without technical training in programming or control and automation systems.

While this invention has been described with reference to illustrative embodiments, this description is not intended to be construed in a limiting sense. Various modifications of the illustrative embodiments, as well as other embodiments of the invention, will be apparent to persons skilled in the art upon reference to this description. It is therefore contemplated that the appended claims will cover any such modifications or embodiments as fall within the true scope of the invention

What is claimed is:

1. A method of adapting a computer to control a device, said method comprising the steps of:
(a) setting up the computer, wherein said setting up comprises constructing a generic operating rule;
(b) receiving by the computer input data from a user, wherein the input data include at least one of: a parameter to be controlled, a desired value for the parameter, and a range of values for the parameter;
(c) the computer populating the generic operating rule of Step (a) with the input data received at Step (b), to convert the generic operating rule to a unique operating rule;
(d) displaying the unique operating rule of Step (c) as a natural language expression; and,
(e) the user verifying the unique operating rule displayed at Step (d),
wherein the computer is adapted to control the device by executing the unique operating rule verified at Step (e).

2. The method of claim 1, wherein the natural language expression displayed at Step (d) is in English.

3. The method of claim 1, wherein the natural language expression displayed at Step (d) is in a non-English natural language.

4. The method of claim 1, wherein the generic operating rule populated at Step (c) comprises at least two operating rules that are concatenated or nested.

5. The method of claim 1, wherein the natural language expression displayed at Step (d) is grammatically correct only if the input data of Step (b) are valid.

6. The method of claim 5, wherein Step (e) comprises determining whether the natural language expression displayed at Step (d) is grammatically correct.

7. The method of claim 6, wherein the generic operating rule populated at Step (c) comprises at least two operating rules that are concatenated or nested.

8. The method of claim 1, wherein the receiving of Step (b) includes the step of the computer writing the input data to a record, and wherein the populating of Step (c) includes the step of the computer reading the input data from the record.

9. The method of claim 8, wherein the natural language expression displayed at Step (d) is constructed from input data read from the record.

10. The method of claim 8, wherein the setting up of Step (a) further comprises the step of constructing a rules variable table, wherein the record is contained in the rules variable table.

11. The method of claim 1, wherein the input data received at Step (b) includes an indicator of what device is to be controlled.

12. The method of claim 1, wherein the natural language expression displayed at Step (d) includes an indicator of what device is to be controlled.

13. The method of claim 1, wherein the natural language expression displayed at Step (d) includes at least one of: i) a day of the week, ii) a date, and iii) a time of day.

14. A computer configured according to claim 1.

15. A method of adapting a computer to control a device, said method comprising the steps of:
(a) configuring the computer to construct a generic operating rule;
(b) configuring the computer to receive input data from a user, wherein the input data include at least one of: a parameter to be controlled, a desired value for the parameter, and a range of values for the parameter;
(c) configuring the computer to populate the generic operating rule of Step (a) with the input data of Step (b), to convert the generic operating rule to a unique operating rule;
(d) configuring the computer to display the unique operating rule of Step (c) as a natural language expression; and,
(e) configuring the computer to receive a user verification of the unique rule displayed at Step (d),
wherein upon receiving the user verification, the computer is adapted to execute the unique operating rule.

16. The method of claim 15, wherein the natural language expression of Step (d) is in English.

17. The method of claim 15, wherein the natural language expression of Step (d) is in a non-English natural language.

18. The method of claim 15, wherein the generic operating rule of Step (c) comprises at least two operating rules that are concatenated or nested.

19. The method of claim 15, wherein the natural language expression of Step (d) is grammatically correct only if the input data of Step (b) are valid.

20. The method of claim 15, wherein the user verification of Step (e) comprises determining whether the natural language expression of Step (d) is grammatically correct.

21. The method of claim 19, wherein the generic operating rule of Step (c) comprises at least two operating rules that are concatenated or nested.

22. The method of claim 15, wherein Step (b) includes the step of configuring the computer to write the input data to a record, and wherein Step (c) includes the step of configuring the computer to read the input data from the record.

23. The method of claim 22, wherein the natural language expression of Step (d) is constructed from the input data read from the record.

24. The method of claim 22, further comprising the step of configuring the computer to establish a rules variable table, wherein the record is contained in the rules variable table.

25. The method of claim 15, wherein the input data of Step (b) include an indicator of what device is to be controlled.

26. The method of claim 15, wherein the natural language expression of Step (d) includes an indicator of what device is to be controlled.

27. The method of claim 15, wherein the natural language expression of Step (d) includes at least one of: i) a day of the week, ii) a date, and iii) a time of day.

28. A computer adapted according to claim 15.
